(19) United States
(12) Patent Application Publication
(10) Pub. No.: US 2024/0281983 A1
(43) Pub. Date: Aug. 22, 2024

(54) METHOD AND SYSTEM OF ANALYZING MOTION BASED ON FEATURE TRACKING

(71) Applicants: POSCO CO., LTD., Pohang-si, Gyeongsangbuk-do (KR); RESEARCH INSTITUTE OF INDUSTRIAL SCIENCE & TECHNOLOGY, Pohang-si, Gyeongsangbuk-do (KR); POSTECH Research and Business Development Foundation, Poshang-si, Gyeongsangbuk-do (KR)

(72) Inventors: Tae Hyun OH, Pohang-si (KR); Hyunwoo HA, Yangsan-si (KR); Sang Hyeok PARK, Pohang-si (KR); Laekyoung LEE, Pohang-si (KR); Jun Young SEO, Daegu (KR)

(73) Assignees: POSCO CO., LTD., Pohang-si, Gyeongsangbuk-do (KR); RESEARCH INSTITUTE OF INDUSTRIAL SCIENCE & TECHNOLOGY, Pohang-si, Gyeongsangbuk-do (KR); POSTECH Research and Business Development Foundation, Pohang-si, Gyeongsangbuk-do (KR)

(21) Appl. No.: 18/292,723

(22) PCT Filed: Nov. 23, 2022
(86) PCT No.: PCT/KR2022/018563

§ 371 Date: Jan. 26, 2024

(30) Foreign Application Priority Data
Dec. 22, 2021 (KR) 10-2021-0185261

(51) Int. Cl. G06T 7/246; G06T 3/4007; G06T 3/60; G06T 7/13; G06V 10/25; G06V 10/44

(52) U.S. Cl. CPC G06T 7/246; G06T 3/4007; G06T 3/60; G06T 7/13; G06V 10/25; G06V 10/44

(57) ABSTRACT

A method of analyzing a motion on the basis of feature tracking is disclosed. The method includes the steps of: capturing image frames; filtering a region of interest (ROI) for the captured image frames; tracking a feature in the captured image frames; removing an extreme value on the basis of an optimum model; and outputting an analysis result.

Further disclosed is a system of analyzing a motion on the basis of feature tracking, the system comprising a controller configured to perform each step of the method.

### CROSS-REFERENCE TO RELATED APPLICATION

This application claims priority to and the benefit of Korean Patent Application No. 10-2021-0185261 filed in the Korean Intellectual Property Office on Dec. 22, 2021, the entire contents of which are incorporated herein by reference.

### TECHNICAL FIELD

The present invention relates to a method and system of analyzing a motion based on feature tracking, and more specifically, to a method and system of analyzing a motion based on feature tracking with improved scalability and stability.

### BACKGROUND ART

Many structures and installations of the social overhead capital (SOC) infrastructures in Korea are more than 30 years old. For safety tests on such infrastructures, accurate motion analysis and frequency analysis techniques based on it are essential. Particularly, due to the characteristics of the infrastructures, many of the infrastructures are huge structures or are not easy for people to access, it is difficult to analyze a motion by contact type sensors, and there is also a risk of safety accidents.

Factories that mainly deal with huge facilities, such as steel mills, refineries, and shipyards and have a risk of safety accidents, also have characteristics similar to those of the social overhead capital with a large number of huge infrastructures and have the same problems. Accordingly, there are obvious limitations in using contact type sensors in factories, and in order to overcome these limitations, a safety test analysis technique using non-contact type sensors is required.

Recent image-based motion measures and analysis techniques have been used as remote monitoring systems for detecting abnormalities from industrial equipment and apparatuses or safety tests on old facilities or the like. However, the larger and more inaccessible facilities, the greater the distances between the facilities and cameras that capture images, and accordingly, it is required to zoom in using expensive lenses. In this case, high cost is caused, and it becomes impossible to analyze areas other than a specific area on which the focus is brought, whereby the advantages of wide-area monitoring are lost.

In order to maintain low cost and take the advantages of wide-area monitoring when the distances between cameras and facilities are far, it should be possible to accurately analyze motions of facilities while using inexpensive lenses. As a solution, an analysis system based on feature tracking that ensures high accuracy with respect to motions in very small units of a sub-pixel unlike the typical vision object tracking techniques exhibiting accuracy in units of a pixel is valid.

The conventional feature tracking techniques have disadvantages in terms of stability and scalability. In terms of stability, there are problems such as detecting motions of unwanted objects or the background, tracking particles that are commonly found in factories, such as dust, or the like. Further, a problem that in terms of scalability is that in the case of the edges of smooth facilities having no regular features consecutively trackable, the side surfaces of high-speed rotating objects, or the like, it is impossible to track, or the tracking trajectories drift and collapse within a short time of 5 to 10 frames. Accordingly, a new analysis system based on feature tracking that can solve or mitigate these problems in terms of stability and scalability is required.

The matters described in the background section are intended to enhance the understanding of the background of the invention and may include matters not previously known to those skilled in the art.

### DISCLOSURE

### Technical Problem

Exemplary embodiments of the present invention attempt to provide a method and a system of analyzing a motion based on feature tracking with improved scalability and stability.

### Technical Solution

A method of analyzing a motion based on feature tracking by a controller according to an exemplary embodiment of the present invention may include receiving an image frame containing an image of a target to determine a reference point and a direction vector of the image, rotating the image on the basis of the reference point and the direction vector of the image, extracting a feature by setting a region of interest centered on the reference point and masking a region other than the region of interest, and tracking the motion of the feature.

When determining the reference point and the direction vector of the images, the reference point and the direction vector may be automatically determined through edge detection.

When determining the reference point and the direction vector of the images, the reference point and the direction vector may be received through a user interface.

When rotating the image on the basis of the reference point and the direction vector of the image, the image is rotated using a rotation matrix and bilinear interpolation such that an X axis and the direction vector match each other.

The region of interest may be set by extending a window that has a width set with the reference point as the center in the X-axis direction, and the region other than the region of interest may be masked in black.

The method may further include obtaining an optimal model on the basis of the motion of the feature, and removing an extreme value on the basis of the optimal model.

The obtaining an optimal model on the basis of the motion of the feature may include calculating an amount of motion between frames at each scale, randomly sampling the amount of motion between frames at each scale to model the amount of motion into a Gaussian model, measuring a likelihood of the amount of each feature on the basis of the Gaussian model, calculating a sum of the likelihood exceeding a set reference value, and determining the Gaussian model having the largest sum of the likelihood exceeding the reference value, as the optimal model.

The removing an extreme value on the basis of the optimal model may include calculating a distance between each feature and a mean of the optimal model, and removing the feature having the distance from the mean of the optimal model larger than a set threshold, as the extreme value.

A method of analyzing a motion based on feature tracking by a controller according to another exemplary embodiment of the present invention may include receiving an image frame containing an image of a target, finding a trackable feature in the image frame, tracking the motion of the feature, obtaining an optimal model on the basis of the motion of the feature, and removing an extreme value on the basis of the optimal model.

The obtaining an optimal model on the basis of the motion of the feature may include calculating an amount of motion between frames at each scale, randomly sampling the amount of motion between frames at each scale to model the amount of motion into a Gaussian model, measuring a likelihood of the amount of each feature on the basis of the Gaussian model, calculating a sum of the likelihood exceeding a set reference value, and determining the Gaussian model having the largest sum of the likelihood exceeding the reference value, as the optimal model.

The removing an extreme value on the basis of the optimal model may include calculating a distance between each feature and a mean of the optimal model, and removing the feature having the distance from the mean of the optimal model larger than a set threshold, as the extreme value.

A system of analyzing a motion based on feature tracking according to yet another exemplary embodiment of the present invention may include an image capturing device that captures an image frame containing an image of a target, and a controller configured to receive the image frame from the image capturing device, extract a trackable feature from the image frame, track a motion of the extracted feature, obtain an optimal model on the basis of the motion of the feature, and remove an extreme value on the basis of the optimal model.

The controller may be configured to calculate an amount of motion between frames at each scale, randomly sample the amount of motion between frames at each scale to model the amount of motion into a Gaussian model, measure a likelihood of the amount of each feature on the basis of the Gaussian model, calculate a sum of the likelihood exceeding a set reference value, and determine the Gaussian model having the largest sum of the likelihood, as the optimal model.

The controller may be configured to calculate a distance between each features and a mean of the optimal model and remove the feature having the distance from the mean of the optimal model larger than a set threshold, as the extreme value.

The controller may be configured to extract the trackable feature from the image frame through region of interest (ROI) filtering.

The controller may be configured to extract the feature by determining a reference point and a direction vector of the image, rotating the image on the basis of the reference point and the direction vector of the image, setting a region of interest centered on the reference point, and masking a region other than the region of interest.

The controller may be configured to automatically determine the reference point and the direction vector through edge detection.

The controller may be configured to rotate the image using a rotation matrix and bilinear interpolation such that an X axis and the direction vector match each other.

The controller may be configured to set the region of interest by extending a window that has a width set with the reference point as the center in the X-axis direction, and mask the region other than the region of interest in black.

### Advantageous Effects

According to the present invention, by improving the scalability and stability of non-contact type motion analysis based on images that can overcome the limitations of contact type sensors to old infrastructures or huge factories, it is possible to lower the cost of image-based analysis, take advantage of wide-area monitoring, and operate stably in more applications. As a result, it is possible to enhance the monitoring and safety test performance on industrial sites and old facilities in various ways.

A method and system of analyzing a motion based on feature tracking according to an exemplary embodiment of the present invention can process motion analysis in real time, and can cope with various inputs, so they can be used in various situations such as real-time monitoring, periodic monitoring, temporary tests, etc. Therefore, they can be applied to safety test schemes that vary depending on purposes and situations, showing high field adaptability, and thus can be used in a variety of general-purpose applications.

Other effects that can be obtained or predicted due to the exemplary embodiment of the present invention will be disclosed directly or implicitly in the detailed description of the exemplary embodiment of the present invention. In other words, various effects that are predicted according to the exemplary embodiment of the present invention will be disclosed in the following detailed description.

### DESCRIPTION OF THE DRAWINGS

Exemplary embodiments in this specification may be better understood with reference to the following description associated with the accompanying drawings in which like reference symbols designate identical or functionally similar elements.

FIG. 1 is a schematic block diagram of a system of analyzing a motion based on feature tracking according to an exemplary embodiment of the present invention.

FIG. 2 is a schematic diagram for explaining region-of-interest filtering.

FIG. 3 is a flow chart of a method of analyzing a motion based on feature tracking according to an exemplary embodiment of the present invention.

FIG. 4 is a flow chart of step S110 in FIG. 3.

FIG. 5 is a flow chart of step S130 in FIG. 3.

FIG. 6 shows an image used to compare feature tracking results according to an exemplary embodiment of the present invention and the related art.

FIG. 7 is a graph illustrating a result of tracking a motion of the image of FIG. 6 on the X axis.

FIG. 8 is a graph illustrating a result of tracking a motion of the image of FIG. 6 on the Y axis.

FIG. 9 shows an image used to demonstrate the performance of an optimization calculation unit according to the exemplary embodiment of the present invention.

FIG. 10 is a bar graph illustrating the distances from the mean of an optimal model using the image of FIG. 9.

The drawings referenced above are not necessarily drawn to scale, and should be understood as presenting a rather simplified representation of various preferred features illustrating the basic principles of the present disclosure. Certain design features of the present disclosure, including, for example, particular dimensions, orientations, locations, and shapes will be determined in part by the particular intended application and environment of use.

### MODE FOR INVENTION

The terms used herein are for the purpose of describing specific examples only and are not intended to limit the present invention. As used herein, unless the context clearly indicates otherwise, the singular form is also intended to include the plural form. The terms “comprising” and/or “comprising” as used herein denote the presence of specified features, integers, steps, actions, elements and/or components, but it will be appreciated that the presence or addition of one or more of other features, integers, steps, actions, elements and/or components should is not excluded. As used herein, the term “and/or” includes any one or all combinations of one or more items listed in association.

Additionally, it will be appreciated that one or more of the following methods or the aspects thereof may be performed by at least one controller. The term “controller” may refer to a hardware device including memories and processors. The memories are configured to store program commands, and the processors are specifically programmed to execute program commands to perform one or more processes to be described below in more detail. A controller may control the operations of units, modules, components, devices, or the like as described herein. Further, it will be appreciated that the following methods may be performed by a device including a controller along with one or more other components as recognized by those skilled in the art.

Furthermore, a controller of the present disclosure may be configured as a non-transitory computer-readable medium containing executable program commands which are executed by a processor. Examples of computer-readable media include ROMs, RAMs, compact disc (CD) ROMs, magnetic tapes, floppy discs, flash drives, smart cards, and optical data storage devices, but are not limited thereto. Computer-readable media may also be distributed throughout a computer network such that program commands can be stored and executed in a distribution manner, such as a telematics server or a controller area network (CAN).

A method and system of analyzing a motion based on feature tracking according to an exemplary embodiment of the present invention assumes a motion on a specific axis, and then applies a black mask to an image such that highly trackable features are formed. Accordingly, tracking is possible even when there are few trackable features of a target or trackable features are unstable, or it is possible to prevent tracking from failing within a short time of 5 to 10 frames in the middle. Further, the method and system of analyzing a motion based on feature tracking according to the exemplary embodiment of the present invention can solve the problem in terms of stability by finding a dominant motion and removing extreme values showing motions different from the dominant motion.

Hereinafter, exemplary embodiments of the present invention will be described in detail with reference to the accompanying drawings.

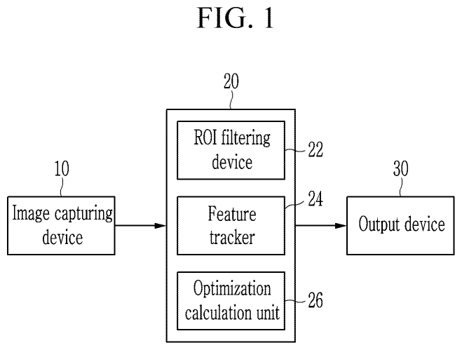

FIG. 1 is a schematic block diagram of a system of analyzing a motion based on feature tracking according to an exemplary embodiment of the present invention.

As shown in FIG. 1, a system of analyzing a motion based on feature tracking according to an exemplary embodiment of the present invention includes an image capturing device 10, a controller 20, and an output device 30.

The image capturing device 10 captures image frames containing images of a target (for example, an infrastructure, a factory, or a huge apparatus) whose motion needs to be analyzed, and transmits the captured image frames to the controller 20. The image capturing device 10 may capture one image frame at a specific time, or may capture a plurality of image frames for a set time. The image capturing device 10 may be a camera.

The controller 20 may receive the image frames from the image capturing device 10, analyzes a motion of the target by performing region of interest (ROI) filtering, feature tracking, and/or extreme value removal, etc., on the received image frames, and transmits the analyzed result to the output device 30. To this end, the controller 20 includes an ROI filtering device 22, a feature tracker 24, and an optimization calculation unit 26.

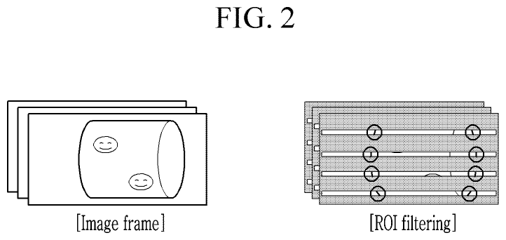

The ROI filtering device 22 performs ROI filtering on the image frames containing the images of the target. As shown in FIG. 2 which is a schematic diagram for explaining region-of-interest filtering, ROI filtering is a technique for forming highly trackable features by forcibly applying a mask to the regions other than regions of interest in image frames. In other words, if a black mask is forcibly applied to an image having few trackable features like the left drawing in FIG. 2, highly trackable features may be formed like the right drawing in FIG. 2. The ROI filtering that is performed in the ROI filtering device 22 will be described below in more detail.

On the basis of a feature in the first image frame of the plurality of image frames, the feature tracker 24 tracks a motion of features by finding similar features in the subsequent image frames. Here, similar features are found in the subsequent image frames according to physical modeling of the target. The feature tracker 24 may output coordinate values as the tracking records of each feature.

The optimization calculation unit 26 obtains an optimal model by finding a dominant motion of the target so as not to output the results of tracking objects which are not subjects of analysis, the background, or particles such as dust, and removes extreme values showing motions different from the dominant motion. The extreme value removal which is performed in the optimization calculation unit 26 will be described below in more detail.

The controller 20 may be configured as one or more processors which are operated by a set program, and the set program may be a program for performing each step of the method of analyzing a motion based on feature tracking according to the exemplary embodiment of the present invention.

The output device 30 may receive the result of analyzing the motion of the target from the controller 20, and display it. For example, the output device 30 may be a display, a speaker, a control server, an external server, and/or a user computing device, and the analysis result which is displayed on the output device 30 may contain a warning.

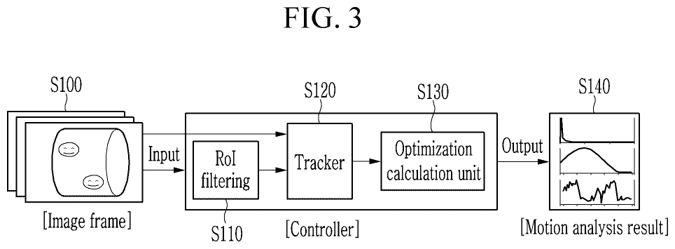

Hereinafter, the method of analyzing a motion based on feature tracking according to the exemplary embodiment of the present invention will be described in detail with reference to FIG. 3 to FIG. 5.

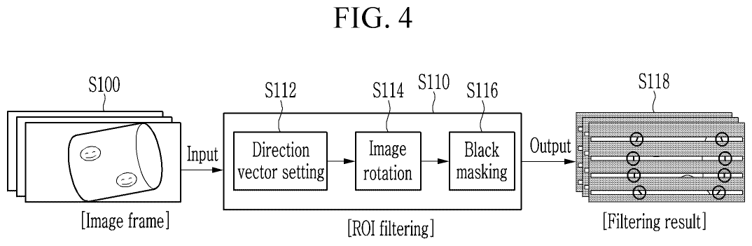

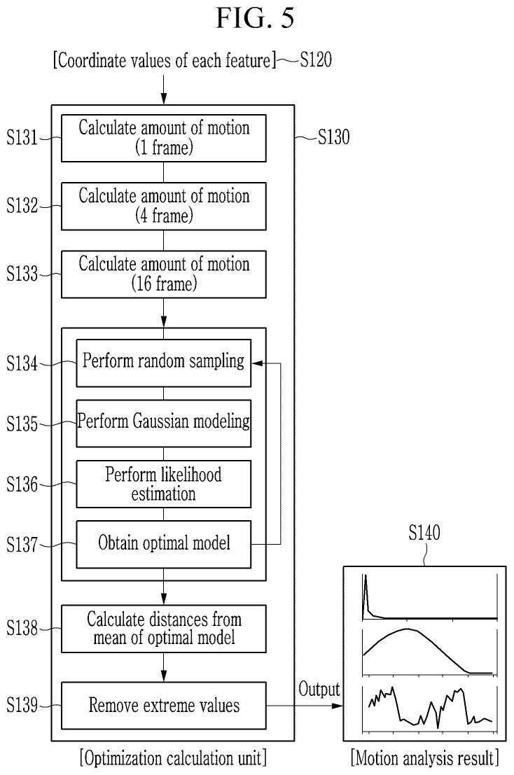

FIG. 3 is a flow chart of the method of analyzing a motion based on feature tracking according to the exemplary embodiment of the present invention, FIG. 4 is a flow chart of step S110 in FIG. 3, and FIG. 5 is a flow chart of step S130 in FIG. 3.

As shown in FIG. 3, the method of analyzing a motion based on feature tracking according to the exemplary embodiment of the present invention includes a step (S100) of capturing image frames, a step (S110) of performing ROI filtering on the captured image frames, a step (S120) of tracking a feature in the captured image frames, a step (S130) of removing extreme values on the basis of an optimal model, and a step (S140) of outputting an analysis result.

As described above, the image capturing device 10 captures image frames containing images of a target at the step S100. The image capturing device 10 captures image frames in real time, or captures image frames periodically or under the control of a user for a set time. In this way, it is possible to cope with situations such as real-time monitoring, periodic monitoring, or temporary tests, etc.

The image frames may be in the form of a general video file, image file, or array. If the images are in RGB, they may be preprocessed to grayscale. The image capturing device 10 transmits the captured image frames or the preprocessed image frames to the controller 20.

When receiving the image frames from the image capturing device 10, the controller 20 finds trackable features through image recognition. If the controller 20 finds a sufficient number of trackable features, the feature tracker 24 performs feature tracking on the plurality of time-series image frames at the step S120. However, if the controller 20 fails to find trackable features or the number of trackable features is small, the ROI filtering device 22 performs ROI filtering at the step S110.

As shown in FIG. 4, the ROI filtering includes a step (S112) of setting a reference point and a direction vector, a step (S114) of rotating an image based on the direction vector, and a step (S116) of performing black masking on the rotated image.

At the step S112, the user determines a reference point and an direction vector in person through a user interface, or a highly responsive point in an image is determined as a reference point through automated edge detection and a direction perpendicular to a detected edge of the reference point is determined as a direction vector.

If a reference point and a direction vector are determined at the step S112, the ROI filtering device 22 rotates the image such that at the reference point, the direction vector matches the direction of a specific axis (for example, the direction of the X axis) at the step S114. As an example, the rotation of the image may be performed using a rotation matrix and bilinear interpolation, but is not limited thereto.

If the image is rotated at the step S114, the ROI filtering device 22 determines a region of interest in which a window having a width set with the reference point as the center extends in the X-axis direction. The present invention is not limited thereto, and the set width may be 3 to 10 pixels. If a region of interest is determined, the region outside the region of interest is masked in black. At this time, a plurality of regions of interest may be determined as in the rightmost drawing of FIG. 4. Further, when several reference points are adjacent, some reference points may collide. In this case, the image is duplicated, and black masking is newly performed on the duplicated images.

The ROI filtering further includes a step (S118) of extracting features. Due to black masking, in the image, the region of interest is transparent, and the other regions are painted black. The ROI filtering device 22 extracts points in the image subjected to black masking whose images overlap the region of interest, as features.

Referring to FIG. 3 again, if features are extracted by the controller 20 or the ROI filtering device 22, on the basis of the features of the first image frame of the plurality of image frames, the feature tracker 24 tracks the motions of features by finding similar features in the subsequent image frames at the step S120. The feature tracker 24 may output coordinate values as the tracking records of each feature.

As shown in FIG. 5, if the coordinate values of each feature are received, the optimization calculation unit 26 obtains an optimal model, and removes extreme values on the basis of the optimal model at the step S130. More specifically, if receiving the tracking records of each feature from the feature tracker 24, the optimization calculation unit 26 first standardizes the data about the tracking records. The method of standardizing the coordinate data is widely known, so a further detailed description will not be made. After standardizing the coordinate data, the optimization calculation unit 26 executes an extreme value removal optimization algorithm.

First, the optimization calculation unit calculates the amounts of motion between every two frames at each scale on the basis of the tracking records provided in the form of coordinates. For example, the optimization calculation unit calculates the amounts of motion over the time interval of one frame at step S131, calculates the amounts of motion over the time interval of four frames at step S132, and calculates the amounts of motion over the time interval of sixteen frames at step S132.

If the amounts of motions between the frames are calculated, the optimization calculation unit 26 randomly samples data on the amounts of motion between the frames at step S134, and models them into bivariate Gaussian models at step S135. Thereafter, the optimization calculation unit 26 measures the likelihoods of the data on the amounts of motion of all features on the basis of each bivariate Gaussian model at step S136, and records the sum of the likelihoods exceeding a set reference value.

The optimization calculation unit 26 repeats the step S134 to the step S136, thereby obtaining a bivariate Gaussian model having the largest sum of likelihoods exceeding the reference value, as an optimal model at step S137. Thereafter, the optimization calculation unit 26 calculates the distances between the individual features and the mean of the optimal model at step S138, and classifies features having large distances from the mean of the optimal model as extreme values, and removes them at step S139. As an example, the optimization calculation unit may remove features having distances from the mean of the optimal model larger than a set threshold, as extreme values. After removing the extreme values, the optimization calculation unit outputs the tracking data of normal features as the analysis result at the step S140.

Hereinafter, feature tracking results according to the exemplary embodiment of the present invention and the related art will be compared.

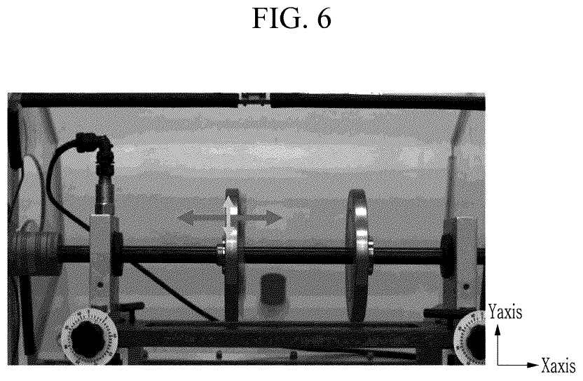

FIG. 6 shows an image used to compare feature tracking results according to the exemplary embodiment of the present invention and the related art. FIG. 6 is an image of a rotation simulator, and it can be seen that the motion on the Y axis is very small as compared to the motion on the X axis.

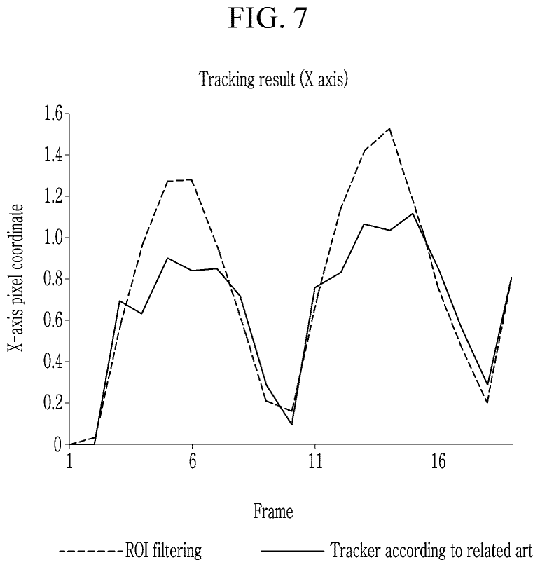

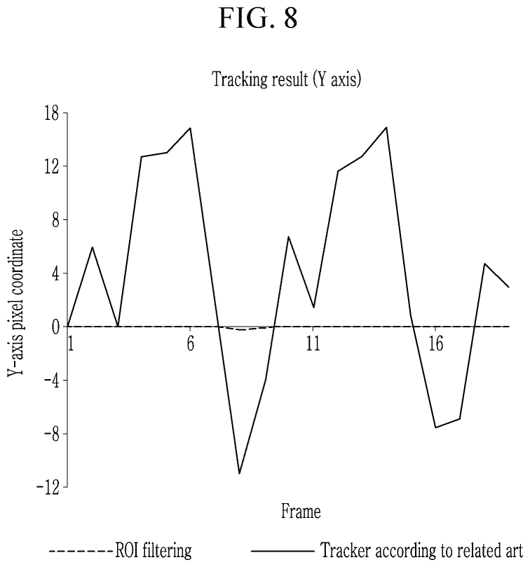

FIG. 7 is a graph illustrating a result of tracking a motion of the image of FIG. 6 on the X axis, and FIG. 8 is a graph illustrating a result of tracking a motion of the image of FIG. 6 on the Y axis. In FIG. 7 and FIG. 8, the dotted lines show the results obtained by tracking the motion of the image after performing ROI filtering according to the exemplary embodiment of the present invention, and the solid lines show the results obtained by tracking the motion of the image without ROI filtering according to the related art. Further, in both of the exemplary embodiment of the present invention and the related art, optimal model calculation and extreme value removal were not performed.

While the result of tracking the motion on the X axis according to the related art shows a curve that is not smooth and is unstable as shown by the solid line in FIG. 7, the result of tracking the motion on the X axis according to the exemplary embodiment of the present invention shows a smooth and stable curve as shown by the dotted line in FIG. 7

Further, it can be seen from the result of tracking the motion on the Y axis according to the related art that the errors of detecting non-existent motions on the Y axis occurred as shown by the solid line in FIG. 8. It can be seen that when the ROI tracker according to the exemplary embodiment of the present invention is used, it is possible to track features as described above even when there are few features or features are unstable.

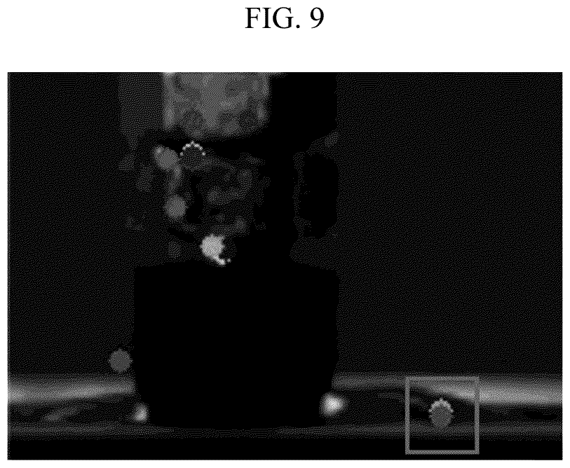

FIG. 9 shows an image used to demonstrate the performance of the optimization calculation unit according to the exemplary embodiment of the present invention. FIG. 9 is a shaker image, and it can be seen that two features in the rectangular box are extreme values showing motions different from that of the target.

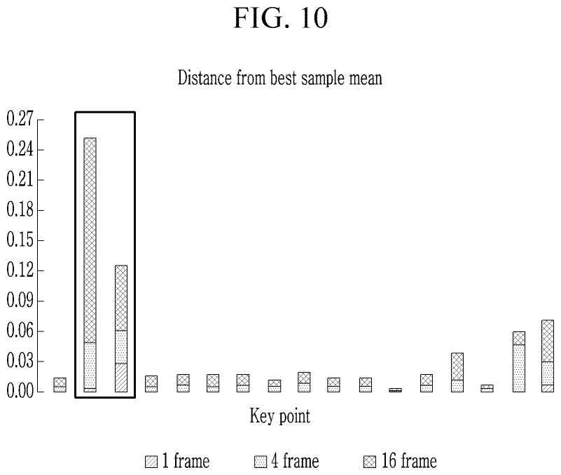

FIG. 10 is a bar graph illustrating the distances from the mean of an optimal model using the image of FIG. 9.

As shown in FIG. 10, as the result of using the optimization calculation unit according to the exemplary embodiment of the present invention, it can be seen that the distances between the two features in the rectangle of FIG. 9 and the mean of the optimal model were relatively large at every scale (between frames). When the optimization calculation unit according to the exemplary embodiment of the present invention is used, the two features in the rectangle of FIG. 9 can be removed as extreme values. Also, it can be seen that if the removal criterion is set wider, several features in FIG. 10 additional become subjects of removal, and these features follow a large motion of the target but vibrate unstably.

Therefore, when the optimization calculation unit according to the exemplary embodiment of the present invention is used, by tracking the motions of untargeted features, it is possible to stabilize a situation in which fluctuations occur in the result, thereby improving the accuracy and reliability of the result value.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. A method of analyzing a motion based on feature tracking by a controller, the method comprising:
receiving an image frame containing an image of a target to determine a reference point and a direction vector of the image;
rotating the image on the basis of the reference point and the direction vector of the image;
extracting a feature by setting a region of interest centered on the reference point and masking a region other than the region of interest; and
tracking the motion of the feature.

2. The method of claim 1, wherein
when determining the reference point and the direction vector of the image,
the reference point and the direction vector are automatically determined through edge detection.

3. The method of claim 1, wherein
when determining the reference point and the direction vector of the image,
the reference point and the direction vector are received through a user interface.

4. The method of claim 1, wherein
when rotating the image on the basis of the reference point and the direction vector of the image,
the image is rotated using a rotation matrix and bilinear interpolation such that an X axis and the direction vector match each other.

5. The method of claim 4, wherein
the region of interest is set by extending a window that has a width set with the reference point as the center in the X-axis direction, and the region other than the region of interest is masked in black.

6. The method of claim 1, further comprising:
obtaining an optimal model on the basis of the motion of the feature; and
removing an extreme value on the basis of the optimal model.

7. The method of claim 6, wherein the obtaining an optimal model on the basis of the motion of the feature comprises:
calculating an amount of motion between frames at each scale;
randomly sampling the amount of motion between frames at each scale to model the amount of motion into a Gaussian model;
measuring a likelihood of the amount of each feature on the basis of the Gaussian model;
calculating a sum of the likelihood exceeding a set reference value; and
determining the Gaussian model having the largest sum of the likelihood exceeding the reference value, as the optimal model.

8. The method of claim 7, wherein the removing an extreme value on the basis of the optimal model comprises:
calculating a distance between each feature and a mean of the optimal model; and
removing the feature having the distance from the mean of the optimal model larger than a set threshold, as the extreme value.

9. A method of analyzing a motion based on feature tracking by a controller, the method comprising:
receiving an image frame containing an image of a target;
finding a trackable feature in the image frame;
tracking the motion of the feature;
obtaining an optimal model on the basis of the motion of the feature; and
removing an extreme value on the basis of the optimal model.

10. The method of claim 9, wherein the obtaining an optimal model on the basis of the motion of the feature comprises:
calculating an amount of motion between frames at each scale;
randomly sampling the amount of motion between frames at each scale to model the amount of motion into a Gaussian model;
measuring a likelihood of the amount of each feature on the basis of the Gaussian model;
calculating a sum of the likelihood exceeding a set reference value; and
determining the Gaussian model having the largest sum of the likelihood exceeding the reference value, as the optimal model.

11. The method of claim 10, wherein the removing an extreme value on the basis of the optimal model comprises:
calculating a distance between each feature and a mean of the optimal model; and
removing the feature having the distance from the mean of the optimal model larger than a set threshold, as the extreme value.

12. A system of analyzing a motion based on feature tracking, the system comprising:
an image capturing device that captures an image frame containing an image of a target; and
a controller configured to receive the image frame from the image capturing device, extract a trackable feature from the image frame, track a motion of the extracted feature, obtain an optimal model on the basis of the motion of the feature, and remove an extreme value on the basis of the optimal model.

13. The system of claim 12, wherein
the controller is configured to calculate an amount of motion between frames at each scale, randomly sample the amount of motion between frames at each scale to model the amount of motion into a Gaussian model, measure a likelihood of the amount of each feature on the basis of the Gaussian model, calculate a sum of the likelihood exceeding a set reference value, and determine the Gaussian model having the largest sum of the likelihood, as the optimal model.

14. The system of claim 13, wherein
the controller is configured to calculate a distance between each feature and a mean of the optimal model and remove the feature having the distance from the mean of the optimal model larger than a set threshold, as the extreme value.

15. The system of claim 12, wherein
the controller is configured to extract the trackable feature from the image frame through region of interest (ROI) filtering.

16. The system of claim 15, wherein
the controller is configured to extract the feature by determining a reference point and a direction vector of the image, rotating the image on the basis of the reference point and the direction vector of the image, setting a region of interest centered on the reference point, and masking a region other than the region of interest.

17. The system of claim 16, wherein
the controller is configured to automatically determine the reference point and the direction vector through edge detection.

18. The system of claim 16, wherein
the controller is configured to rotate the image using a rotation matrix and bilinear interpolation such that an X axis and the direction vector match each other.

19. The system of claim 18, wherein
the controller is configured to set the region of interest by extending a window that has a width set with the reference point as the center in the X-axis direction, and mask the region other than the region of interest in black.
